(19) United States
(12) Patent Application Publication
(10) Pub. No.: US 2022/0220307 A1
(43) Pub. Date: Jul. 14, 2022

(54) POLYISOCYANURATE THERMOSETS WITH IMPROVED MECHANICAL PROPERTIES

(71) Applicant: Covestro LLC, Pittsburgh, PA (US)

(72) Inventor: Liang Chen, Sewickley, PA (US)

(21) Appl. No.: 17/148,647

(22) Filed: Jan. 14, 2021

(51) Int. Cl. C08L 79/00; C08G 18/02

(52) U.S. Cl. CPC C08L 79/00; C08G 18/022

(57) ABSTRACT

Provided is a polyisocyanurate thermoset comprising a mixture of an aliphatic polyisocyanate, optionally, an aromatic polyisocyanate; a core-shell rubber (CSR) impact modifier; and a catalyst, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture. Also provided is a process of producing a polyisocyanurate thermoset comprising reacting in the presence of a catalyst, a mixture of an aliphatic polyisocyanate, optionally, an aromatic polyisocyanate, and a core-shell rubber (CSR) impact modifier, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture. The thermosets of the invention may find use in producing composites such as wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

### FIELD OF THE INVENTION

The present invention relates in general to thermosetting polymers, and more specifically, to polyisocyanurate-based thermosets having improved mechanical properties and methods of preparing composites from those thermosets.

### BACKGROUND OF THE INVENTION

The use of fiber reinforced composite materials having a thermosetting polymer matrix and reinforcing fibers has been growing in the aerospace, automotive, and construction industries, where light weight, excellent mechanical properties, and corrosion resistance are desired. Typical thermosetting polymers are unsaturated polyester, epoxy, and polyurethane. Although composite materials deliver highly differentiated performance, they struggle to achieve long term UV and weathering resistance. They all have aromatic monomer units that absorb UV light, causing degradation of the polymer matrix. In EP2777915B1, a two-component, aliphatic polyurethane system was developed. This system showed good weathering properties in addition to excellent mechanical properties.

Compared to polyurethane, polyisocyanurates are known for good thermal stability and chemical resistance. In particular, polyisocyanurates based on aliphatic isocyanates have very good weathering resistance.

U.S. Pat. Pub. 2019/255788 provides a new thermoset technology based on aliphatic polyisocyanates that are unaffected by UV radiation, and have excellent weathering resistance. The liquid resin with improved pot-life at room temperature can be used as a one-component system and it has rapid curing at elevated temperatures. These novel composites are particularly suitable for outdoor applications. This technology has been applied to established composite manufacturing processes such as pultrusion. However, the resin properties are still lacking when compared to two-component polyurethanes. It is highly desired to toughen polyisocyanate resin properties so that the resultant composites show better mechanical properties.

U.S. Pat. No. 10,544,253 discloses a method for improving the fracture toughness of polyisocyanurate materials comprising a polyisocyanate composition, an isocyanate-reactive composition including at least 50 mol % diols and an acrylic block copolymer toughening agent. This patent states that although the fracture toughness of polyisocyanurate materials may be increased by adding core shell particles, the addition of solid particles to a liquid resin may cause stability issues.

To reduce or eliminate problems, therefore, a need exists in the art for a method of improving the mechanical properties of polyisocyanurate resins with, at most, minimal negative effects.

### SUMMARY OF THE INVENTION

Accordingly, the present invention reduces or eliminates problems inherent in the art by providing a method of improving the mechanical properties of polyisocyanurate thermosets by introducing suitable impact modifiers. Surprisingly, the core-shell rubber (CSR) particles suspended in a polyol carrier are compatible with polyisocyanate blends, so that they can uniformly disperse in the liquid resin and remain dispersed throughout the curing process. This approach is applicable to one-component, aliphatic polyisocyanate blends and to more reactive polyisocyanate blends containing aromatic polyisocyanates. As a result, the invention provides thermosets with improved tensile properties (i.e. elongation at break, tensile strength), despite a minor reduction of tensile modulus.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first aspect, the present invention is directed to a polyisocyanurate thermoset comprising a mixture of an aliphatic polyisocyanate, optionally, an aromatic polyisocyanate; a core-shell rubber (CSR) impact modifier; and a catalyst, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture.

In a second aspect, the present invention is directed to process of producing a polyisocyanurate thermoset comprising reacting in the presence of a catalyst, a mixture of an aliphatic polyisocyanate, optionally, an aromatic polyisocyanate, and a core-shell rubber (CSR) impact modifier, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture.

In a third aspect, the present invention is directed to composites made from thermosets according to the previous two paragraphs. Such composites may take the form of pultruded wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

As used herein, the term “polymer” encompasses prepolymers, oligomers, and both homopolymers and copolymers; the prefix “poly” in this context refers to two or more. As used herein, the term “molecular weight”, when used in reference to a polymer, refers to the number average molecular weight, unless otherwise specified.

As used herein, the term “polyol” refers to compounds comprising at least two free hydroxy groups. Polyols include polymers comprising pendant and terminal hydroxy groups.

A “composite” or “composite composition” refers to a material made from one or more polymers, containing at least one other type of material (e.g., a fiber) which retains its identity while contributing desirable properties to the composite. A composite has different properties from those of the individual polymers/materials which make it up.

The terms “cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

A “thermoset” is a polymer that irreversibly becomes rigid when heated. Initially, the polymer is a liquid or soft solid. Heat provides energy for chemical reactions that increase the cross-linking between polymer chains, curing the plastic. The rate of curing may be increased by increasing pressure or by adding a catalyst.

As indicated, the thermoset compositions of the present invention comprise a polyisocyanate. As used herein, the term “polyisocyanate” refers to compounds comprising at least two unreacted isocyanate groups, such as three or more unreacted isocyanate groups. The polyisocyanate may comprise diisocyanates such as linear aliphatic polyisocyanates, cycloaliphatic polyisocyanates and alkaryl polyisocyanates.

A “polyisocyanurate” resin is a resin having an isocyanurate ring structure obtained by trimerization of polyisocyanate. Polyisocyanurate resins are prepared by reaction of a polyisocyanate in the presence of a catalyst such as an isocyanuration (trimerization) catalyst. A “polyisocyanurate” means any molecule having a plurality of isocyanurate structural units, e.g., at least ten isocyanurate structural units. A molecule having a single isocyanurate structural unit is referred to as an “isocyanurate”.

A “prepolymer” means an oligomeric compound having functional groups which are involved in the final construction of polymers. It comprises, as is usual in polyurethane chemistry, compounds which contain at least one diisocyanate unit and at least one diol unit and are polymerizable further via the functional groups of these units.

A “composite polyisocyanurate material” means a composite material wherein the polymeric matrix material is a polymer containing polyisocyanurate. The polymeric matrix material may also comprise predominantly, or entirely, a polyisocyanurate. A polymeric matrix material composed of blends of polyisocyanurates and other plastics is likewise encompassed by the term “composite polyisocyanurate material”. The composite polyisocyanurate material may include allophanates and other side products.

Suitable aliphatic diisocyanates and prepolymers and polyisocyanates for use in the mixtures of the present invention are clear and colorless and have a viscosity at 25° C. of less than 5000 centipoises. Examples of such aliphatic polyisocyanates include those represented by the formula,

Q(NCO)ₙ

wherein n is a number from 2-5, in some embodiments from 2-3, and Q is an aliphatic hydrocarbon group containing 2-12, in certain embodiments from 4-6, carbon atoms or a cycloaliphatic hydrocarbon group containing 4-6, in selected embodiments from 5-6, carbon atoms.

Examples of aliphatic diisocyanates which are suitable for use in the present invention include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and 1,4-diisocyanate, 1-isocyanato-2-isocyanato-methyl cyclopentane, 5-isocyanato-1-(isocyanatomethyl)-1,3,3-trimethylcyclohexane (IPDI), bis-(4-isocyanatocyclohexyl)methane, 1,3- and 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate (H₁₂MDI), pentane diisocyanate (PDI), and, isomers of any of these; or combinations of any of these. Mixtures of diisocyanates may also be used. Preferred diisocyanates include 1,6-hexamethylene diisocyanate, isophorone diisocyanate, and bis(4-isocyanatocyclohexyl)-methane because they are readily available and yield relatively low viscosity polyisocyanate formulations.

The aliphatic isocyanate can comprise at least one of a polyisocyanate comprising a biuret group, such as the biuret adduct of hexamethylene diisocyanate (HDI) available from Covestro AG under the trade designation DESMODUR N-100, a polyisocyanate containing an isocyanurate group, such as that available from Covestro AG under trade designation DESMODUR N-3300, a polyisocyanate such as that available from Covestro AG under the tradename DESMODUR N-3600, which has a viscosity of 800-1400 mPa·s at 25° C., and a polyisocyanate containing at least one of an iminooxadiazine dione group, a urethane group, a uretdione group, a carbodiimide group, and an allophanate group.

Aliphatic isocyanate-terminated prepolymers may also be employed in the present invention. as those skilled in the art are aware, prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known to those skilled in the art. The use of any one specific active hydrogen compound is not critical; any such compound can be employed in the practice of the present invention. In certain embodiments, the polyisocyanate comprises blend based on a hexamethylene diisocyanate trimer and a dicyclohexylmethane-4,4-diisocyanate prepolymer.

Suitable aromatic isocyanates include, but are not limited to methylene diphenyl diisocyanate (MDI), 1,3-phenylene diisocyanate, 1,4-phenylene diisocyanate, 2,6-toluene diisocyanate (2,6-TDI), 2,4-toluene diisocyanate (2,4-TDI), polymethylene polyphenyl polyisocyanate (PMDI), 1,5-naphthalene diisocyanate (NDI), p-phenylene diisocyanate (PPDI), xylene diisocyanate (XDI), 1,3-xylylene diisocyanate, 1,4-xylylene diisocyanate, tetramethylxylene diisocyanate, 3,3′-dimethyl-4,4′-biphenylene diisocyanate, 3,3′-dimethoxy-4,4′-biphenylene diisocyanate, 2,4,6-triisopropyl-m-phenylene diisocyanate, triphenylmethane-4,4′,4″-triisocyanate, tris(p-isocyanatophenyl)thiophosphate, oligomers, polymers, isomers thereof, prepolymers thereof, and combinations thereof.

The polyisocyanurates of the invention are obtainable by catalytic trimerization by the process of the invention. “Catalytic” as used herein means in the presence of a suitable trimerization catalyst. Catalysts for the formation of polyisocyanurates (i.e., trimerization catalysts) include metal-type catalysts, such as alkali metal carboxylates, metal alcoholates, metal phenolates and metal hydroxides, tertiary amines, quaternary ammonium salts, tertiary phosphines, and phosphorus onium salts. These trimerization catalysts are often used in combination with other catalysts which promote the reaction of isocyanates with water and/or polyols to obtain a synergistic effect. Suitable catalysts include binary or ternary blends of tertiary amine, such as pentamethyldiethylenetriamine, dimethylcyclohexylamine or dimethylethanolamine and potassium organo-salts such as potassium octoate or potassium acetate.

Suitable trimerization catalysts for the processes of the invention are in principle all compounds which comprise at least one quaternary ammonium and/or metal salt and which are suitable for accelerating the trimerization of isocyanate groups to isocyanurate structures. According to the invention, the trimerization catalyst comprises at least one quaternary ammonium and/or metal salt as catalyst. In the context of the invention, a “quaternary ammonium” is understood to mean a compound of the formula NR₄⁺ where the “R” radical comprises organic radicals, especially alkyl or aryl radicals. Preferably, the quaternary ammonium is a compound of the formula NR₄⁺ where each of the R radicals is independently a linear or branched alkyl radical having 1 to 5 carbon atoms.

Suitable trimerization catalysts comprise, as metal salt, carboxylates and alkoxides of metals. In various embodiments of the invention, the trimerization catalysts include metal salts of aliphatic carboxylic acids having 1 to 20 and in some embodiments, 1 to 10 carbon atoms, for example metal salts of formic acid, acetic acid, propionic acid, butyric acid, valeric acid, caproic acid, enanthic acid, caprylic acid, pelargonic acid and capric acid. In selected embodiments, the catalysts include acetate salts.

In some embodiments of the invention, the trimerization catalyst comprises, as metal component, an element selected from the group consisting of alkali metals, alkaline earth metals, tin, zirconium, zinc, iron, and titanium.

In various embodiments of the invention, the trimerization catalyst comprises, as metal component, an alkali metal or alkaline earth metal. In certain embodiments, the metal components are sodium and potassium.

In an embodiment of the invention, the trimerization catalyst comprises, as metal component, an alkaline alkali metal salt or alkaline earth metal salt which, as a saturated aqueous solution, has a pH of greater than 7, in certain embodiments greater than 8, and in selected embodiments, greater than 9 (measured with litmus paper) at 23° C. Particular preference is given to sodium salts and potassium salts.

In other embodiments, the metal salt is an alkali metal acetate or octoate or alkaline earth metal acetate or octoate, most preferably an alkali metal acetate. In various embodiments of the invention, tin octoate is preferred.

In certain embodiments, the trimerization catalyst also includes a polyether carrier solvent (40-95) wt %. Polyethers are selected from the group consisting of crown ethers, polyethylene glycols, and polypropylene glycols. It has been found to be of particular relevance in the process of the invention to use a trimerization catalyst comprising, as polyether, a polyethylene glycol, or a crown ether, more preferably 18-crown-6 or 15-crown-5. In some embodiments, the trimerization catalyst may comprise a polyethylene glycol having a number-average molecular weight of 100 g/mol to 1000 g/mol, in certain embodiments, of 106 g/mol to 1000 g/mol, in selected embodiments, 200 g/mol to 800 g/mol, especially 300 g/mol to 500 g/mol and most especially 350 g/mol to 450 g/mol. The term “polyethylene glycol” as used herein includes diethylene glycol.

Preferred trimerization catalysts useful in the invention include potassium acetate or potassium octoate as alkali metal salt and polyethylene glycols as polyether, especially potassium acetate and polyethylene glycol having a number-average molecular weight of 400 g/mol.

The present inventors have unexpectedly found that the inclusion of core-shell rubber (CSR) impact modifiers in polyisocyanurate-based thermosets can have beneficial effects on the mechanical properties of those materials. To be useful in the present invention, the core-shell rubber (CSR) impact modifiers must be dispersible in liquid isocyanates. For example, the core rubber phase can be styrene-butadiene, polybutadiene, or silicone rubber. In various embodiments, the core-shell rubber (CSR) particles are 25 wt % to 40 wt % in a carrier. The core-shell rubber (CSR) particles are preferably dispersed in a carrier that is highly miscible with polyisocyanates. The carrier preferably reacts slowly with isocyanate groups at ambient temperature and quickly reacts with isocyanate groups at elevated temperatures such as upon heating. As disclosed in co-assigned application, U.S. Ser. No. 16/951,017, the polyols easily miscible with polyisocyanates are preferably used as a carrier for the core-shell rubber (CSR) particles, for example, polypropylene glycol. As those skilled in the art are aware, incompatibility between the polyol carrier and the isocyanate component leads to phase separation and thus, inhomogeneous distribution of rubber particles.

The core-shell rubber (CSR) particles (excluding the carrier polyol) in various embodiments are from 0.5 wt. % to 10 wt. %, in certain embodiments, 1 wt. % to 7.5 wt. %, and in selected embodiments 2 wt. % to 6 wt. %, wherein the wt. % is based upon the weight of the thermoset.

In the invention, pultrusion of polyisocyanurate thermosets with fiber reinforced composites may be performed in a closed injection box or preferably in an open bath process, in which reinforcement material in the form of fibers, mat or roving is pulled continuously through an open bath of polyisocyanurate to produce an impregnated reinforcement. The impregnated reinforcement is pulled through form plates to remove excess resin, and then through a curing die to cure the resin and yield a finished product. The pultrusion apparatus may optionally contain a plurality of curing dies, or zones. Different curing zones may be set at different temperatures, if desired, but all the zones of the curing die will be higher in temperature than the impregnation bath. The impregnation bath is set at a temperature that provides for substantially no reaction (polymerization) between the polyisocyanurate component and the polyisocyanate-reactive component in the polyisocyanurate-forming formulation before the fibrous reinforcing structure, enters the first curing die (or zone).

A long fiber based reinforcing material is necessary to provide mechanical strength to the pultruded composite of the invention, and to allow the transmission of the pulling force in the process. Fibers should be at least long enough to pass though both the impregnation and curing dies and attach to a source of tension. In various embodiments of the invention, the fibrous reinforcing material is made of any fibrous material or materials that can provide long fibers capable of being at least partially wetted by the polyisocyanurate formulation during impregnation. The fibrous reinforcing material may be single strands, braided strands, woven or non-woven mat structures and combinations thereof. Mats or veils made of long fibers may be used, in single ply or multi-ply structures.

Suitable fibrous materials are known in the pultrusion art, include, but are not limited to, glass fibers, glass mats, carbon fibers, polyester fibers, natural fibers, aramid fibers, nylon fibers, basalt fibers and combinations thereof. In some embodiments of the invention the fibrous reinforcing materials are long glass fibers. In various embodiments, the fibers and/or fibrous reinforcing structures may be formed continuously from one or more reels feeding into the pultrusion apparatus and attached to a source of pulling force at the outlet side of the curing die. In certain embodiments, the reinforcing fibers may optionally be pre-treated with sizing agents or adhesion promoters known to those skilled in the art.

The weight percentage of the long fiber reinforcement in the pultruded composites may vary considerably, depending on the end use application intended for the composite articles. In various embodiments of the invention, reinforcement loadings may be from 30 wt. % to 95 wt. %, in some embodiments from 40 wt. % to 90 wt. %, based on the weight of the final composite, in certain other embodiments from 60 wt. % to 90 wt. %, and in various other embodiments from 70 wt. % to 90 wt. %, based on the weight of the final composite. The long fiber reinforcement may be present in the pultruded composites in an amount ranging between any combination of these values, inclusive of the recited values.

In the process of producing the polyisocyanurate pultrusion composite, the polyisocyanurate component and the isocyanate-reactive component may be the only components fed into the process. The polyisocyanurate component or the isocyanate-reactive component may be premixed with any optional additives. However, it is to be understood that the optional additives that are not themselves polyfunctional isocyanate-reactive materials are to be considered (counted) as entities separate from the isocyanate-reactive component, even when mixed therewith. Likewise, if the optional additives, or any part thereof, are premixed with the polyisocyanurate component, these are to be considered as entities separate from the polyisocyanurate component, except in the case where they are themselves polyfunctional isocyanate species.

The pultrusion formulation may contain other optional additives, if desired. Examples of additional optional additives include particulate or short fiber fillers, internal mold release agents, fire retardants, smoke suppressants, dyes, pigments, antistatic agents, antioxidants, UV stabilizers, minor amounts of viscosity reducing inert diluents, combinations of these, and any other known additives from the art. In some embodiments of the present invention, the additives or portions thereof may be provided to the fibers, such as by coating the fibers with the additive.

Optional internal mold release agents may be nonionic surfactants containing perfluoroalkyl or polysiloxane units that are known as mold release agents; quaternary alkylammonium salts, for example trimethylethylammonium chloride, trimethylstearylammonium chloride, dimethylethylcetylammonium chloride, triethyldodecylammonium chloride, trioctylmethylammonium chloride and diethylcyclohexyldodecylammonium chloride; acidic monoalkyl and dialkyl phosphates and trialkyl phosphates having 2 to 18 carbon atoms in the alkyl radical, such as, ethyl phosphate, diethyl phosphate, isopropyl phosphate, diisopropyl phosphate, butyl phosphate, dibutyl phosphate, octyl phosphate, dioctyl phosphate, isodecyl phosphate, diisodecyl phosphate, dodecyl phosphate, didodecyl phosphate, tridecanol phosphate, bis(tridecanol) phosphate, stearyl phosphate, distearyl phosphate; waxes such as beeswax, montan wax or polyethylene oligomers; metal salts and esters of oily and fatty acids, such as barium stearate, calcium stearate, zinc stearate, glycerol stearate and glycerol laurate, esters of aliphatic branched and unbranched alcohols having 4 to 36 carbon atoms in the alkyl radical; and any desired mixtures of such mold release agents.

In selected embodiments, the optional mold release agents are the fatty acid esters and salts thereof mentioned, and also acidic mono- and dialkyl phosphates mentioned, most preferably those having 8 to 36 carbon atoms in the alkyl radical.

Internal mold release agents, where used in the process, according to various embodiments of the invention, in amounts of 0.01 wt. % to 15.0 wt. %, in certain embodiments of 0.02 wt. % to 10.0 wt. %, in selected embodiments of 0.05 wt. % to 7.0 wt. %, in very select embodiments of 0.1 wt. % to 5 wt. % by weight and in particular embodiments of from 0.3 wt. % to 3 wt. %, calculated as the total amount of internal mold release agent used, based on the total weight of the polyisocyanate composition.

It has been found that the addition of fatty acid salts, especially stearate salts, to the polyisocyanate composition allows the tensile forces in pultrusion to be considerably lowered under otherwise identical conditions. At the same time, there is a distinct rise in surface quality of the pultrudates, the surface becomes smoother and abrasion at the heating mold outlet is distinctly reduced. Moreover, because of the lower friction, the pultrusion rate (for a given tensile force) can be increased, which makes the process more efficient.

Consequently, in various embodiments of the invention, stearate salts, such as zinc stearate or calcium stearate, are used as the demolding agent, with preference being given to zinc stearate. These mold release agents are used in various embodiment in amounts of less than 10 wt. %, in certain embodiments of less than 5 wt. %, in selected embodiments of less than 2 wt. % and in particular embodiments of less than 1 wt. %, based on the total weight of the polyisocyanate composition. In various embodiments, the polyisocyanate composition contains at least 0.001 wt. % of stearate salts, in certain embodiments of greater than 0.01 wt. %, in selected embodiments of greater than 0.1 wt. % and in particular embodiments greater than 0.25 wt. %, based on the total weight thereof.

In certain embodiments of the invention, stearate salts, such as zinc stearate and/or calcium stearate and or zinc stearate, are used in combination with one or more other internal mold release agents in the pultrusion. Other mold release agents may be phosphoric esters, fatty acids, fatty acid esters or amides, siloxane derivatives, long-chain alcohols, for example isotridecanol, waxes and montan waxes, and any desired mixtures thereof. The mixing ratio between the stearate salt and the other mold release agents can be optimized according to the profile form and the pultrusion conditions, but is in various embodiments less than 90 wt. %, in certain embodiments, less than 50 wt. %, in selected embodiments less than 30 wt. % and in very select embodiments, between 2 wt. % and 25 wt. % of stearate salt, based on the amount of all internal mold release agents used. The total content of all internal mold release agents is as set out above.

Other optional additives for use in pultrusion include moisture scavengers, such as molecular sieves; defoamers, such as polydimethylsiloxanes; coupling agents, such as the mono-oxirane or organo-amine functional trialkoxysilanes; combinations of these and the like. The coupling agents are included for improving the bonding of the matrix resin to the fiber reinforcement. Fine particulate fillers, such as clays and fine silicas, may be used at thixotropic additives. Such particulate fillers may also serve as extenders to reduce resin usage. Fire retardants are sometimes desirable as additives in pultruded composites. Examples of suitable fire-retardant types include, but are not limited to, triaryl phosphates; trialkyl phosphates, especially those bearing halogens; melamine (as filler); melamine resins (in minor amounts); halogenated paraffins and combinations thereof.

The pultrusion composites of the invention may find use in or as a variety of products, including, but not limited to, wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated. The following materials were used in preparation of the Examples.

A standard polyisocyanurate system for pultrusion applications includes three components: aliphatic polyisocyanates such as ISOCYANATE A, a trimerization catalyst, and an internal mold release agent. In this study, additional polyisocyanates were investigated such as ISOCYANATE B and ISOCYANATE C. These materials are listed in Table I.

TABLE I

| | | Viscosity | | | |
|---|---|---|---|---|---|
| ISO- | NCO | @ 25° C. | NCO | Equiv. | |
| CYANATE | wt % | (mPa · s) | Functionality | Wt. | Composition |
| A | 23.5 | 1000 | 3.2 | 183 | HDI Trimer |
| B | 26.4 | 280 | 2.0 | 159 | H₁₂MDI |
| | | | | | prepolymer |
| C | 16.5 | 600 | 2.0 | 255 | MDI prepolymer |

The trimerization catalysts are summarized in Table II. DABCO K2097 was obtained from Air Products and is 33 wt. % potassium acetate (KAc) in diethylene glycol. CATALYST A was diluted DABCO K2097 catalyst in PEG400.

TABLE II

| CATALYST | Composition | KAc (wt.%) |
|---|---|---|
| A | DABCO K2097 diluted in PEG400 | 5 |
| B | KAc in PEG400 | 5 |

The core-shell rubber (CSR) impact modifier used was a styrene-butadiene core-shell rubber 40 wt. % suspended in polypropylene glycol which was miscible in liquid isocyanates and is commercially available from Kaneka as KANE ACE MX-714. It is intended for toughening thermosetting polyurethane.

The mold release agent was zinc stearate dispersed in fatty acid ester.

### Sample Preparation and Analysis

Polyisocyanurate thermoset formulations were prepared using the following procedure. Polyisocyanates and modifiers were mixed on a speed mixer (FLACKTEK INC.) at 2000 rpm for one minute. The catalyst was mixed into the mixture using the speed mixer for one-minute at 2000 rpm. An internal mold release agent was excluded unless specified otherwise. The formulation was measured within 30 minutes of preparation by using various analytical methods. A portion of the formulation was poured into an aluminum pan and thermally cured at set temperatures (150° C. or 180° C.) in an oven, and the cured solid samples were used for further analysis. A portion of formulation was also stored in a plastic container to monitor the gel time at ambient temperature. The sample curing speed (change from a liquid to a solid) was measured by pouring 5 g of the liquid formulation into an aluminum pan (˜5 cm diameter) on a hot plate with the surface temperature setting at 180° C.

Cured resin plaques with uniform thickness (e.g. 3.0 mm) were prepared for physical property characterization. The polyisocyanurate formulations were prepared as above, followed by degassing on a speed mixer under vacuum (50 mbar) for three minutes. The formulation was poured onto a first glass plate with 3 mm thick TEFLON spacers. The glass plate and liquid mixture were covered with a second glass plate and clamped using binder clips to prevent sample leakage during the thermal curing process. The samples were cured in an oven at 150° C. or 180° C. for 30 minutes.

### Resin Characterization

Differential Scanning calorimetry (DSC) evaluations were performed on a PerkinElmer DSC 800 instrument using 20° C./min heating and cooling ramps. Nitrogen was used as the furnace purge gas. Samples were initially cooled to −25° C. and held isothermally for three minutes, then heated to 250° C. After a one-minute isothermal hold, samples were cooled back to −25° C. and held isothermally for three minutes. Finally, the samples were reheated to 250° C.

### Physical Characterization of Resins and Composites

The cured polyisocyanurate plaques were mechanically milled at ambient temperature to the desired specimen dimensions for testing. The physical properties were measured using the following methods. The specific density of the samples was determined according to ASTM D792. The tensile tests were measured according to ASTM D638 at 23° C. The flexural tests were measured according to ASTM D790 at 25° C.

### Resin Modification with Impact Modifiers

Although as mentioned elsewhere herein, a previous patent suggested that conventional dry powder core-shell rubber particles fail to toughen polyisocyanurate resins, the present inventors decided to examine this approach in polyisocyanurate thermosets with a new impact modifier containing core-shell rubber (CSR) particles dispersed in a polyol carrier. This impact modifier is said to be more compatible with polyurethane resins. Three sets of examples using different isocyanates were prepared. The first set used low reactivity aliphatic polyisocyanate blends (ISOCYANATE A/ISOCYANATE B), the second set used more reactive polyisocyanate blends containing an aromatic polyisocyanate (ISOCYANATE B/ISOCYANATE C), and the third set used only ISOCYANATE A. The core-shell rubber (CSR) particles were compatible with these different polyisocyanate resins. The cured resin samples appeared translucent. These modifier particles (<300 nm) should be well dispersed in the cured polyisocyanurate matrix to achieve the best impact modification.

TABLE III

| Component | Ex. III-A | Ex. III-B | Ex. III-C | Ex. III-D |
|---|---|---|---|---|
| ISOCYANATE B | 72 | 68.25 | 64.5 | 60.75 |
| ISOCYANATE C | 24 | 22.75 | 21.5 | 20.25 |
| CATALYST A | 4 | 4 | 4 | 4 |
| IMPACT MODIFIER | 0 | 5 | 10 | 15 |
| Elongation at break (MPa) | 2.2 | 3.8 | 9.3 | 6.6 |
| Tensile modulus (MPa) | 2638 | 2294 | 2282 | 2390 |
| Tensile strength (MPa) | 46.2 | 63.0 | 69.8 | 61.7 |
| Flex modulus (MPa) | 3270 | 3066 | 2746 | — |
| Flex strength (MPa) | 140 | 143.4 | 141.8 | — |

—: not measured

The results of the first set of examples are summarized in Table III. Unexpectedly, the tensile properties of cured polyisocyanurate thermosets were markedly improved by adding 5-15 wt. % of the core-shell impact (CSR) modifier, although the tensile modulus was slightly reduced. Among all the examples, Ex. III-B containing 10 wt. % IMPACT MODIFIER (40 wt. % rubber particles) exhibited the best tensile properties. The results of the second and third sets of samples are summarized in Table IV. Comparable results were observed in the blends of ISOCYANATE A and ISOCYANATE B, but the improvement of tensile properties was not as great. In ISOCYANATE A, despite improved tensile elongation by adding 10 wt. % IMPACT MODIFIER, the tensile strength was reduced. Without wishing to be bound to any theory, the present inventors believe that that this impact modifier has poor compatibility with the less polar ISOCYANATE A resin. Overall, including core-shell impact modifiers provides another effective method of improving polyisocyanurate thermoset properties.

Table IV summarizes the properties of thermosets made from ISOCYANATE A/ISOCYANATE B blends and from ISOCYANATE A alone.

TABLE IV

| | Ex. IV-A | Ex. IV-B | Ex. IV-C | Ex. IV-D |
|---|---|---|---|---|
| ISOCYANATE A | 72 | 68.25 | 96 | 86 |
| ISOCYANATE B | 24 | 22.75 | 0 | 0 |
| CATALYST B | 4 | 4 | 4 | 4 |
| IMPACT MODIFIER | 0 | 5 | 0 | 10 |
| Elongation at break (%) | 2.7 | 4.1 | 3.2 | 7.3 |
| Tensile modulus (MPa) | 2120 | 2078 | 2020 | 1810 |
| Tensile strength | 44.7 | 58.4 | 51.7 | 46 |
| at break (MPa) | | | | |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A polyisocyanurate thermoset comprising a mixture of an aliphatic polyisocyanate, optionally, an aromatic polyisocyanate; a core-shell rubber (CSR) impact modifier; and a catalyst, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture.

Clause 2. The polyisocyanurate thermoset according to Clause 1, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

Clause 3. The polyisocyanurate thermoset according to one of Clauses 1 and 2, wherein the aromatic polyisocyanate is selected from the group consisting of methylene diphenyl diisocyanate (MDI), 1,3-phenylene diisocyanate, 1,4-phenylene diisocyanate, 2,6-toluene diisocyanate (2,6-TDI), 2,4-toluene diisocyanate (2,4-TDI), polymethylene polyphenyl polyisocyanate (PMDI), 1,5-naphthalene diisocyanate (NDI), p-phenylene diisocyanate (PPDI), xylene diisocyanate (XDI), 1,3-xylylene diisocyanate, 1,4-xylylene diisocyanate, tetramethylxylene diisocyanate, 3,3′-dimethyl-4,4′-biphenylene diisocyanate, 3,3′-dimethoxy-4,4′-biphenylene diisocyanate, 2,4,6-triisopropyl-m-phenylene diisocyanate, triphenylmethane-4,4′,4″-triisocyanate, tris(p-isocyanatophenyl)thiophosphate, oligomers, polymers, isomers thereof, prepolymers thereof, and combinations thereof.

Clause 4. The polyisocyanurate thermoset according to any one of Clauses 1 to 3, wherein the catalyst is a trimerization catalyst.

Clause 5. The polyisocyanurate thermoset according to Clause 4, wherein the trimerization catalyst is an alkali metal salt or an alkaline earth metal salt.

Clause 6. The polyisocyanurate thermoset according to Clause 5, wherein the salt is selected from the group consisting of alkoxides, amides, phenoxides, carbonates, hydrogencarbonates, hydroxides, cyanides, isocyanides, thiocyanides, sulfides, sulfites, sulfinates, phosphites, phosphinates, phosphonates, phosphates, and fluorides.

Clause 7. The polyisocyanurate thermoset according to one of Clauses 5 and 6, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

Clause 8. The polyisocyanurate thermoset according to any one of Clauses 1 to 7, wherein the mold release agent is selected from the group consisting of zinc stearate, calcium stearate, phosphoric esters, fatty acids, fatty acid esters, fatty acid amides, siloxane derivatives, long-chain alcohols, waxes, montan waxes, and mixtures thereof.

Clause 9. The polyisocyanurate thermoset according to any one of Clauses 1 to 8, wherein the core-shell rubber (CSR) impact modifier comprises from 0.5 wt. % to 10 wt. %, based on the weight of the thermoset.

Clause 10. The polyisocyanurate thermoset according to any one of Clauses 1 to 8, wherein the core-shell rubber (CSR) impact modifier comprises from 1 wt. % to 7.5 wt. %, based on the weight of the thermoset.

Clause 11. The polyisocyanurate thermoset according to any one of Clauses 1 to 8, wherein the core-shell rubber (CSR) impact modifier comprises from 2 wt. % to 6 wt. %, based on the weight of the thermoset.

Clause 12. A composite comprising a reaction product of the polyisocyanurate thermoset according to any one of Clauses 1 to 11.

Clause 13. The composite according to Clause 12, wherein the composite is pultruded.

Clause 14. The composite according to one of Clauses 11 and 12, wherein the composite comprises one selected from the group consisting of wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

Clause 15. A process of producing a polyisocyanurate thermoset comprising reacting in the presence of a catalyst, a mixture of an aliphatic polyisocyanate, optionally, an aromatic polyisocyanate, and a core-shell rubber (CSR) impact modifier, optionally, a mold release agent, wherein the aliphatic polyisocyanate is present in the mixture in an amount in excess of the aromatic polyisocyanate, and wherein the core-shell rubber (CSR) impact modifier is uniformly dispersible in the mixture.

Clause 16. The process according to Clause 15, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

Clause 17. The process according to one of Clauses 15 and 16, wherein the aromatic polyisocyanate is selected from the group consisting of methylene diphenyl diisocyanate (MDI), 1,3-phenylene diisocyanate, 1,4-phenylene diisocyanate, 2,6-toluene diisocyanate (2,6-TDI), 2,4-toluene diisocyanate (2,4-TDI), polymethylene polyphenyl polyisocyanate (PMDI), 1,5-naphthalene diisocyanate (NDI), p-phenylene diisocyanate (PPDI), xylene diisocyanate (XDI), 1,3-xylylene diisocyanate, 1,4-xylylene diisocyanate, tetramethylxylene diisocyanate, 3,3′-dimethyl-4,4′-biphenylene diisocyanate, 3,3′-dimethoxy-4,4′-biphenylene diisocyanate, 2,4,6-triisopropyl-m-phenylene diisocyanate, triphenylmethane-4,4′,4″-triisocyanate, tris(p-isocyanatophenyl)thiophosphate, oligomers, polymers, isomers thereof, prepolymers thereof, and combinations thereof.

Clause 18. The process according to any one of Clauses 15 to 17, wherein the thermoset comprises from 0.5 wt. % to 10 wt. %, based the weight of the thermoset, of the core-shell rubber (CSR) impact modifier.

Clause 19. The process according to any one of Clauses 15 to 17, wherein the thermoset comprises from 1 wt. % to 7.5 wt. %, based the weight of the thermoset, of the core-shell rubber (CSR) impact modifier.

Clause 20. The process according to any one of Clauses 15 to 17, wherein the thermoset comprises from 2 wt. % to 6 wt. %, based the weight of the thermoset, of the core-shell rubber (CSR) impact modifier.

Clause 21. A composite comprising the polyisocyanurate thermoset according to any one of Clauses 15 to 120.

Clause 22. The composite according to Clause 21, wherein the composite is pultruded.

Clause 23. The composite according to one of Clauses 21 and 22, wherein the composite comprises one selected from the group consisting of wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

What is claimed is:

1. A polyisocyanurate thermoset comprising a mixture of:
an aliphatic polyisocyanate,
optionally, an aromatic polyisocyanate;
a core-shell rubber (CSR) impact modifier; and
a catalyst,
optionally, a mold release agent,
wherein the aliphatic polyisocyanate is present in the mixture in an amount in excess of the aromatic polyisocyanate, and wherein the core-shell rubber (CSR) impact modifier is uniformly dispersible in the mixture.

2. The polyisocyanurate thermoset according to claim 1, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

3. The polyisocyanurate thermoset according to claim 1, wherein the aromatic polyisocyanate is selected from the group consisting of methylene diphenyl diisocyanate, 1,3-phenylene diisocyanate, 1,4-phenylene diisocyanate, 2,6-toluene diisocyanate, 2,4-toluene diisocyanate, polymethylene polyphenyl polyisocyanate, 1,5-naphthalene diisocyanate, p-phenylene diisocyanate, xylene diisocyanate, 1,3-xylylene diisocyanate, 1,4-xylylene diisocyanate, tetramethylxylene diisocyanate, 3,3′-dimethyl-4,4′-biphenylene diisocyanate, 3,3′-dimethoxy-4,4′-biphenylene diisocyanate, 2,4,6-triisopropyl-m-phenylene diisocyanate, triphenylmethane-4,4′,4″-triisocyanate, tris(p-isocyanatophenyl)thiophosphate, oligomers, polymers, isomers thereof, prepolymers thereof, and combinations thereof.

4. The polyisocyanurate thermoset according to claim 1, wherein the catalyst is a trimerization catalyst.

5. The polyisocyanurate thermoset according to claim 4, wherein the trimerization catalyst is an alkali metal salt or an alkaline earth metal salt.

6. The polyisocyanurate thermoset according to claim 5, wherein the salt is selected from the group consisting of alkoxides, amides, phenoxides, carbonates, hydrogencarbonates, hydroxides, cyanides, isocyanides, thiocyanides, sulfides, sulfites, sulfinates, phosphites, phosphinates, phosphonates, phosphates, and fluorides.

7. The polyisocyanurate thermoset according to claim 5, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

8. The polyisocyanurate thermoset according to claim 1, wherein the mold release agent is selected from the group consisting of zinc stearate, calcium stearate, phosphoric esters, fatty acids, fatty acid esters, fatty acid amides, siloxane derivatives, long-chain alcohols, waxes, montan waxes, and mixtures thereof.

9. The polyisocyanurate thermoset according to claim 1, wherein the core-shell rubber (CSR) impact modifier comprises from 0.5 wt. % to 10 wt. %, based on the weight of the thermoset.

10. The polyisocyanurate thermoset according to claim 1, wherein the core-shell rubber (CSR) impact modifier comprises from 1 wt. % to 7.5 wt. %, based on the weight of the thermoset.

11. The polyisocyanurate thermoset according to claim 1, wherein the core-shell rubber (CSR) impact modifier comprises from 2 wt. % to 6 wt. %, based on the weight of the thermoset.

12. A composite comprising a reaction product of the polyisocyanurate thermoset according to claim 1.

13. The composite according to claim 12, wherein the composite is pultruded.

14. The composite according to claim 12 wherein the composite comprises one selected from the group consisting of wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.

15. A process of producing a polyisocyanurate thermoset comprising reacting in the presence of a catalyst, a mixture of
an aliphatic polyisocyanate,
optionally, an aromatic polyisocyanate, and
a core-shell rubber (CSR) impact modifier,
optionally, a mold release agent,
wherein the aliphatic polyisocyanate is present in the mixture in an amount in excess of the aromatic polyisocyanate, and wherein the core-shell rubber (CSR) impact modifier is uniformly dispersible in the mixture.

16. The process according to claim 15, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

17. The process according to claim 15, wherein the aromatic polyisocyanate is selected from the group consisting of methylene diphenyl diisocyanate, 1,3-phenylene diisocyanate, 1,4-phenylene diisocyanate, 2,6-toluene diisocyanate, 2,4-toluene diisocyanate, polymethylene polyphenyl polyisocyanate, 1,5-naphthalene diisocyanate, p-phenylene diisocyanate, xylene diisocyanate, 1,3-xylylene diisocyanate, 1,4-xylylene diisocyanate, tetramethylxylene diisocyanate, 3,3′-dimethyl-4,4′-biphenylene diisocyanate, 3,3′-dimethoxy-4,4′-biphenylene diisocyanate, 2,4,6-triisopropyl-m-phenylene diisocyanate, triphenylmethane-4,4′,4″-triisocyanate, tris(p-isocyanatophenyl)thiophosphate, oligomers, polymers, isomers thereof, prepolymers thereof, and combinations thereof.

18. A composite comprising the polyisocyanurate thermoset made according to the process of claim 15.

19. The composite according to claim 18, wherein the composite is pultruded.

20. The composite according to claim 19, wherein the composite comprises one selected from the group consisting of wind turbine blades, yacht shells, window frames, door frames, ladder frames, telegraph pole cross arms, tent poles, solar cell frames, solar cell backsheets, radomes, highway guard rails, floor boards, pipes, telegraph poles, auto trunks, luggage holders, engine covers, golf clubs, tennis poles, badminton poles, bicycle frames, surfboards, and snowboards.
